(19) United States
(12) Patent Application Publication
(10) Pub. No.: US 2020/0114774 A1
(43) Pub. Date: Apr. 16, 2020

(54) CHARGING STATION

(71) Applicants: Stefan Helnerus, Arnsberg (DE); Jürgen Waffner, Essen (DE)

(72) Inventors: Stefan Helnerus, Arnsberg (DE); Jürgen Waffner, Essen (DE)

(73) Assignee: innogy SE, Essen (DE)

(21) Appl. No.: 16/716,002

(22) Filed: Dec. 16, 2019

Related U.S. Application Data
(63) Continuation of application No. PCT/EP2018/057756, filed on Mar. 27, 2018.

(30) Foreign Application Priority Data
Jun. 16, 2017 (DE) 10 2017 113 224.4

(51) Int. Cl. B60L 53/31; H02G 3/04

(52) U.S. Cl. CPC B60L 53/31; H02G 3/0493

(57) ABSTRACT

Embodiments of a charging station for electric vehicles are disclosed. The charging station includes a housing, charging electronics arranged in the housing, a pole arranged next to the housing and leading a charging cable out of the housing, and a foundation supporting the housing. In the charging station, a base plate is arranged between the housing and the foundation for fastening the pole, and the pole is fastened to the base plate.

### CROSS-REFERENCE TO RELATED PATENT APPLICATIONS

This patent application is a continuation of PCT/EP2018/057756, filed Mar. 27, 2018, which claims priority to German Application No. 10 2017 113 224.4, filed Jun. 16, 2017, the entire teachings and disclosure of which are incorporated herein by reference thereto.

### FIELD

The subject matter relates to a charging station for electric vehicles comprising a housing, charging electronics arranged in the housing, a pole arranged adjacent to the housing and leading a charging cable out of the housing, and a foundation supporting the housing.

### BACKGROUND

The distribution of charging stations for electric vehicles will be decisive for the acceptance of electromobility. Electrically powered vehicles require a charging infrastructure, which is why charging stations for electric vehicles are increasingly being installed in public and semi-public spaces. In particular, electric vehicles can be battery-powered electric vehicles (BEV, Battery Electric Vehicles) or plug-in hybrids (PHEV, Plug-in Hybrid Electric Vehicles). Electric vehicles can also be electric two-wheelers, for example electric scooters.

An important aspect of the charging stations is convenient access to or connection with the charging station. There are two different concepts for this. On the one hand, there is the concept that the users of the electric vehicles carry the charging cable with them and connect the charging cable to both the charging station and the electric vehicle for the charging process. The second concept is that the charging cables are fixedly mounted to the charging stations and only the charging cable plug at the end of the cable has to be plugged into the vehicle to use the charging station.

In the latter variant in particular, the charging cable is permanently attached to the charging station and must be stowed there in such a way that there is no danger to pedestrians or cyclists. In particular, the charging cable mounted to the charging station must not become a tripping hazard for pedestrians or cyclists. Damage to the charging cable caused by driving over it should also be avoided.

In order to protect the charging cable from damage and to prevent it from lying on the ground, there are charging stations where the charging cable is led on a pole. Usually, the pole towers above the housing of the charging electronics and is more than two meters high, for example between two and three meters. The charging cable is flexibly guided along this pole (also called gallow/boom) and is led to the pole when not in use and can be pulled away from the pole by the user when in use.

However, the installation of such a pole is challenging, as large lever forces can occur at the bottom of the pole and the pole must be securely protected against buckling.

### BRIEF SUMMARY

The subject matter was therefore based on the object of providing a charging station with a housing and a pole, which is particularly easy to install.

This object is solved by a charging station as described herein.

Charging stations for electric vehicles can be designed differently. An essential design form is characterised by a single housing, wherein the housing encloses the charging electronics and is formed as a charging pillar. The second group of designs also has a housing with the charging electronics and a pole next to it, to which the charging cable is attached. In order to keep the costs for the installation of a charging station as low as possible, the aim is to keep the number of different installation processes as low as possible.

When installing a charging station, the excavation must first be carried out. The foundation must then be laid in the area of the excavation and the electrical connections must be routed through the foundation on the ground side. It has been shown that prefabricated foundation parts as standard components for standard charging stations are particularly cost-effective. These can be manufactured in a standardized, industrial environment and are therefore less prone to errors than foundations that are cast individually on site. In addition, the installation of a prefabricated foundation is considerably faster, so that prefabricated foundations are usually used which are placed in the excavation. The excavation must then be filled in and the charging station mechanically fastened to the foundation. Finally, the electrical installation of the charging electronics must take place inside the charging station.

As explained above, prefabricated foundations are particularly suitable for uncomplicated installation of the charging station. However, prefabricated foundations are prefabricated for certain form factors of housings and cannot simply be used for other housings. In particular, if a pole is to be installed in addition to the actual housing for the charging station with the charging electronics, a suitable foundation would have to be constructed using conventional methods. This led to a reduction in the number of units of the respective prefabricated foundations, as these are divided between the different designs of the charging stations.

According to the invention, it has now been recognized that a foundation provided for a conventional charging station can be sufficient to attach the pole to it. To achieve this, a base plate is arranged between the housing and the foundation. The pole is attached to the base plate. The base plate is thus a separate component arranged between the housing and the foundation, which can be provided as required. If a charging station without pole is installed, a base plate is not necessary. On the other hand, when installing a charging station with a pole, the conventional foundation can be used and the base plate placed on it first. Then both the housing and the pole are attached to the base plate. The foundation then supports both the housing and the pole via the base plate. Thus a foundation can be used for a charging station with pole as well as for a charging station without pole.

The base plate is fixed between the bottom of the housing and the top of the ground foundation. In particular, the base plate is screwed between the base of the housing and the foundation.

The pole is attached to the base plate on its lower side according to an embodiment. The pole can be screwed or welded to the base plate.

According to an embodiment it is proposed that the pole has a spring balancer. The charging cable can be attached to the spring balancer. In particular, the spring balancer is arranged in the area of the upper end of the pole. The spring balancer can be housed in a housing of the pole which, for example, closes off the top end of the pole. The spring balancer can have a rope, with which the charging cable is fastened. The charging cable can be pulled away from the pole via the spring balancer. In the unloaded state, the spring balancer pulls the charging cable back to the pole, so that it does not lie on the ground.

The pole can also be a spring pole or have a spring pole and the charging cable can be led through the spring of the spring pole. By the spring pole the charging cable is flexibly fastened at the pole and can be moved if necessary relative to the pole and/or relative to the housing.

According to an embodiment it is proposed that the charging cable is connected to the spring balancer at least in the area of the charging cable connector. In particular, the charging cable is connected in the area of the charging cable plug with a rope connected to the spring balancer. This ensures that the charging cable plug is always pulled in the direction of the pole in the unloaded state and preferably does not remain on the ground after a charging process has been completed.

The charging cable can also alternatively or cumulatively be connected in a central area between the charging cable plug and the housing with the spring balancer, if necessary via a rope. By adjusting the spring forces of the spring balancer appropriately, the charging cable can be balanced and the user can easily bring the charging cable up to the vehicle. The weight of the charging cable can be compensated at least in parts by the spring balancer.

According to an embodiment, the base plate is metallic. It is particularly easy to assemble in order to realize different distances between housing and pole if necessary. In addition, the base plate can be punched from a sheet metal, for example. In particular, the base plate can have a material thickness of between 0.5 mm and 5 cm. The base plate is preferably made of stainless steel.

According to an embodiment, the base plate has at least the size of the base area of the housing and/or the pole. This means that the housing with its base can stand up completely on the base plate. The same applies preferably to the pole, which can stand up with its base completely on the base plate. This leads to a high stability of the housing as well as of the pole at the base plate.

According to an embodiment it is proposed that the base plate has a flange protruding in the direction of the pole and that the pole encloses the flange on its bottom side. It is also possible that the bottom side of the pole is enclosed by the flange. The flange is preferably a fixing aid. The base plate is preferably formed as a flat part and only where the pole is fixed can the flange protrude from the flat surface in the manner of a stop. The pole can then be put over this flange. It is also possible for the flange to receive the pole so that the pole is inserted into the flange. In both cases, after the pole has been placed on the flange, the pole can be attached to the flange. It is possible, for example, that the pole is fastened with bolts or screws pointing radially towards the center of the flange. The flange itself can be welded or screwed to the base plate. In particular, an axial screw or bolt can be provided through the flange and base plate, which fastens the flange to the base plate.

According to an embodiment, it is proposed that the base plate has a cable bushing. In particular, the base plate has a cable bushing in the area where the bottom of the housing rests on the base plate. In this way, an underground cable used to supply the charging electronics with electrical power can be led both through the foundation and through the base plate into the interior of the housing.

In the event that the charging cable is routed inside the pole, a cable bushing can also be provided in the base plate in the area of the pole.

According to an embodiment, the charging cable is firmly attached to the housing. This means that the charging station is formed by the charging cable in addition to the housing and the pole. This firmly attached cable is guided by guide means arranged on the pole, for example the spring balancer.

According to an embodiment, it is proposed that the pole has a longitudinally extending cavity that is open at the bottom. The pole is therefore tubular and open at the bottom so that it can preferably be placed on the flange. In this case it can be advantageous if the charging cable is led through the cable entry into the cavity on the ground side. Then the charging cable can be routed from the bottom of the pole to an upper area inside the cavity and out of the cavity of the pole. In this case, the cable can be protected by deflection rollers in the area where the cable passes through the pole.

Inside the pole, the charging cable can be guided by a pulley. This can be responsible for the cable being pulled back into the pole when it is unloaded. A user can then pull the cable out of the pole and plug it into the electric vehicle using a pulling force. At the end of the charging process, the cable is then pulled back into the pole by the pulley.

According to an embodiment, it is proposed that the base plate has a groove between the housing and the flange on the side facing the foundation. The groove is thus covered by the base plate and runs between the foundation and the base plate. In this groove the charging cable can be routed between the housing and the pole.

With the help of the base plate according to the subject matter, it is particularly easy to install a charging station with a housing and a pole.

### BRIEF DESCRIPTION OF THE DRAWINGS

In the following, the subject matter is explained in more detail using a drawing showing embodiments. In the drawing:

FIG. 1 shows a schematic view of a housing of a charging station with a foundation;

FIG. 2 shows a schematic view of the structure according to FIG. 1 with a base plate;

FIG. 3 shows a top view of a base plate according to an embodiment;

FIGS. 4a),b) show views of a base plate according to an embodiment;

FIG. 5 shows view of a base plate according to an embodiment;

FIG. 6 shows a schematic view of the attachment of a pole to a flange;

FIG. 7 shows another schematic view of a mounting of a pole to a flange;

FIG. 8 shows another schematic view of the attachment of a pole to a flange;

FIG. 9 shows a charging station with a housing and a pole according to an embodiment;

FIG. 10 shows a charging station with a housing and a pole according to another embodiment; and

FIG. 11 shows a charging station with a housing and a pole according to another embodiment.

### DETAILED DESCRIPTION

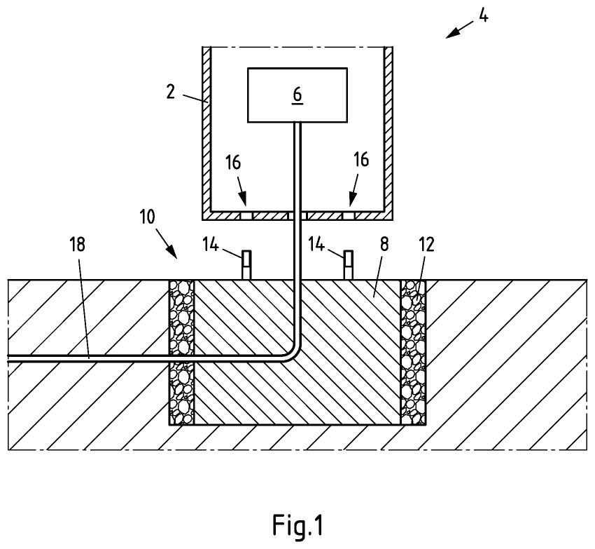

FIG. 1 shows a schematic cross-sectional view of a housing 2 of a charging station 4 with charging electronics 6. The charging electronics 6 are housed inside the housing 2.

The housing 2 can be placed on a foundation 8. Foundation 8 is preferably a concrete foundation, in particular a concrete casting. Foundation 8 can be a prefabricated casting, which is inserted into an excavation 10. Then the excavation 10 is filled with a filling material.

On the foundation 8, protruding screws or bolts 14 are preferably provided on the upper side. The bolts 14 are firmly anchored in the foundation and correspond with openings 16 in the base of the housing 2.

To install charging station 4, first excavation 10 is made. Then an underground cable 18, which establishes an electrical connection to an electrical supply network, is led into the excavation 10. It is also possible that the underground cable 18 is already in excavation 10.

Then the foundation 8 is inserted into the excavation 10 and the underground cable 18 is led through an opening in the foundation 8 to the top of the foundation 8. The excavation 10 is then filled with filling material 12 so that the foundation 8 is held securely in the ground.

Then the housing 2 with its openings 16 is placed on the bolts 14 and screwed to the bolts 14. This ensures that the housing 2 stands securely on the foundation 8.

Finally, the charging electronics 6 are connected to the underground cable 18 so that the charging station 4 is electrically connected.

However, it is the case that not only charging stations with a single housing 2 are put into operation, but also charging stations that are equipped with an additional pole in addition to the housing 2. The pole is usually located on the side of housing 2. The pole is usually used to guide a charging cable which is mounted to housing 2, so that it does not lie on the ground in the rest position and can be pulled from this rest position by the user into a use position. The charging cable should be able to be pulled as flexibly as possible to different positions in the use position, which is why the pole preferably guarantees a return of the charging cable to its rest position.

In order to ensure that the charging cable does not rest on the ground in the rest position, the pole has a certain height, e.g. over 2 m, especially over 2.50 m, especially over 2.80 m, e.g. 2.85 m. However, such a pole must not tip over, so that this pole also needs a foundation.

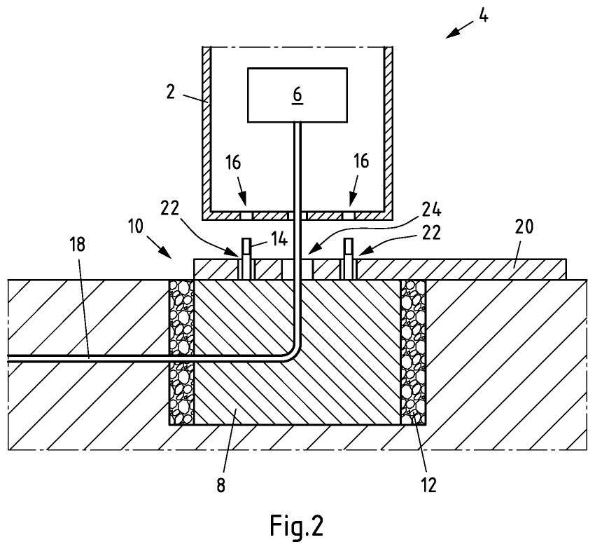

It has now been recognised that it is advantageous if the foundation 8 of a conventional charging station with only one housing 2 can also be used for fixing the pole, as shown in FIG. 2. In addition to the elements shown in FIG. 1, FIG. 2 also has the base plate 20. The base plate 20 is preferably made of metal. The base plate 20 is preferably a flat part. The base plate 20 is in particular a metal plate, in particular made of stainless steel. The base plate 20 is preferably a punched part which has been punched out of a metal sheet.

The base plate 20 has at least 22 openings corresponding to the bolts 14. Before the housing 2 is placed on the base plate 8, the base plate 20 with the openings 22 is pushed over the bolts 14. Then the housing 2 is placed with the openings 16 on the bolts 14 as described above and screwed there. This screw connection ensures that the base plate 20 is fixed between the housing 2 and the foundation 8 by the bolts 14.

It can also be seen that the base plate 20 can project beyond the base area of the foundation 8 and, for example, lies on the ground. However, this is not a problem as the base plate 20 provides sufficient stability for a pole which can then be placed on the base plate 20. The base plate 20 thus forms the foundation for the pole and is itself anchored in the ground via a foundation 8.

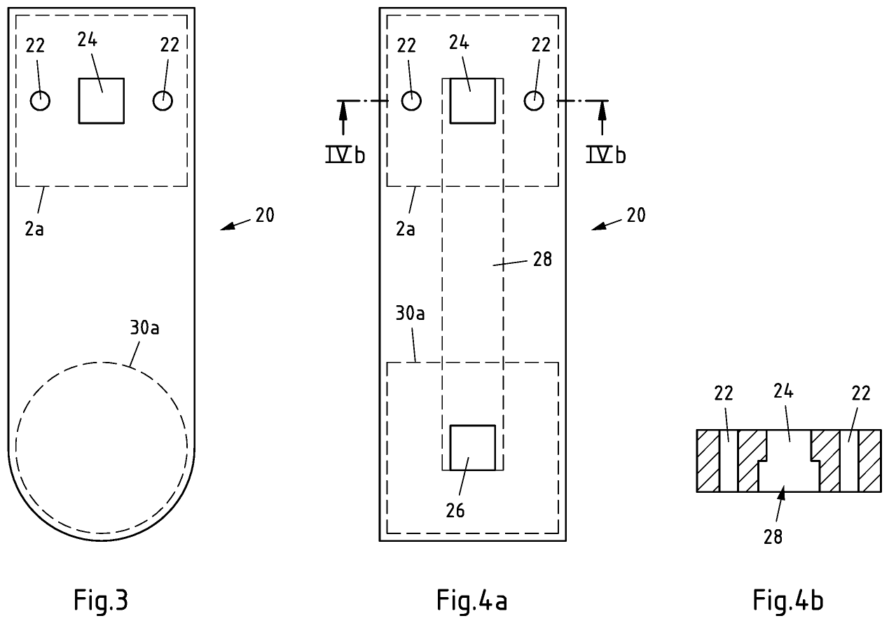

The base plate 20 is shown as an example in FIGS. 3 to 5 according to embodiments.

FIG. 3 shows a top view of a base plate 20. The openings 22 corresponding to the bolts 14 can be seen. In addition, the base plate 20 has a cable bushing 24, which can also be seen in FIG. 2. Through the cable bushing 24, the underground cable 18 can be led through from the foundation 8 in the direction of the housing 2.

FIG. 3 also shows an example of a base plate 20. With the dotted lines, the base areas of both the housing 2 are represented by the dotted lines 2a, and of a pole by the dotted lines 30. As can be seen, the shape of the base plate 20 is adapted to the base areas 2a and 30a. For example, one end of the base plate 20 may be shaped to be congruent with part of the base of housing 2 and another end of the base plate 20 may be shaped to be congruent with part of the base of the pole. Thus the base plate 20 is covered as well as possible by the case 2 and the pole and the base plate 20 does not form a tripping hazard.

FIG. 4a) shows another embodiment of a base plate 20. Here, too, it can be seen that the base plate 20 at the respective ends is at least partially adapted to the base areas 2a, 30a of housing 2 and pole. In addition, it can be seen that a further cable bushing 26 is provided in addition to the cable bushing 24 for the underground cable 18. The cable bushing 26 is preferably in the area where the base of the pole stands on the base plate 20. The cable bushing 26 serves to lead a charging cable, which is led from the charging electronics 6 in the direction of the electric vehicle, first from the housing 2 into the interior of the pole.

In addition, the base plate 20 has a groove 28. The groove 28 runs preferably on the side of the base plate 20, which in the assembled state is directed in the direction of the foundation 8. Furthermore, the groove 28 preferably runs between the two cable bushings 24, 26.

The groove 28 is shown in the sectional view according to FIG. 4b). There you can see that the groove 28 is aligned with the cable bushings 24, 26. Furthermore, the openings 22 are arranged to the side of the groove 28.

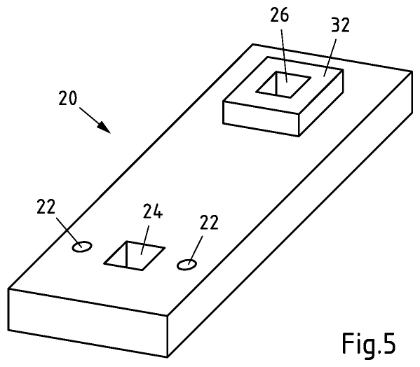

FIG. 5 shows another embodiment of a base plate 2, where the flange 32 is also shown, with which the pole can be attached to the base plate 20.

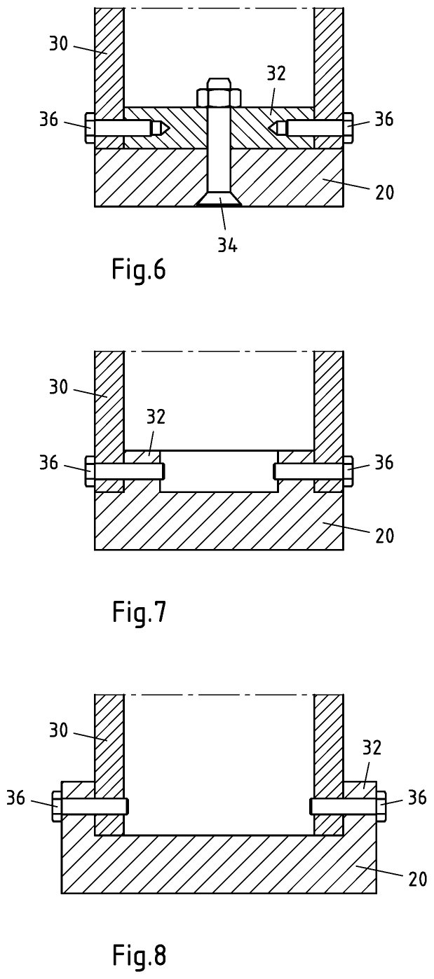

The base area of flange 32 is preferably geometrically similar to the base area of the pole. In particular, the flange 32 is geometrically congruent with an opening in the bottom of the pole. The flange 32 is preferably formed in one piece from the base plate 20 or formed on the base plate 20. The flange 32 can be connected to the base plate 20 in a material-locked or force-locked manner. If necessary, the cable bushing 26 can be continued in flange 32. Possible flanges 32 for connecting a pole to the base plate 20 are shown in FIGS. 6 to 8.

FIG. 6 shows a cross-section through a base plate 20 and a flange 32. A base of the pole 30 is attached to the flange 32.

As can be seen, the flange 32 is screwed to the base plate 20 with a screw 34. The pole 30 can then be pushed over the flange 32. Finally, the pole 30 is screwed to the flange 32 on the bottom side, in the area of a bottom edge. This gives the pole 30 a sufficient hold. The screws 36 are preferably arranged circumferentially around the pole in equal angular distances to each other. Preferably four, six, eight or ten screws 36 are provided to screw the pole 30 to the flange 32. This also applies to the other embodiments. Other fasteners, e.g. bolts or rivets, can also be used instead of the screws.

FIG. 7 shows another embodiment of a base plate 20 in which the flange 32 is formed in one piece with the base plate 20. The flange is formed by a preferably completely circumferential projection from the surface of the base plate 20. The pole 30 is put over the flange 32 on the bottom side. Then a screw connection is made with the screws 36.

It is also possible that the flange 32 embraces the pole 30 as shown in FIG. 8. In this case the flange 32 is also preferably formed completely circumferentially and forms a receptacle for the bottom of the pole 30. After the pole 30 has been inserted into the flange 32, it can be screwed together with the screws 36.

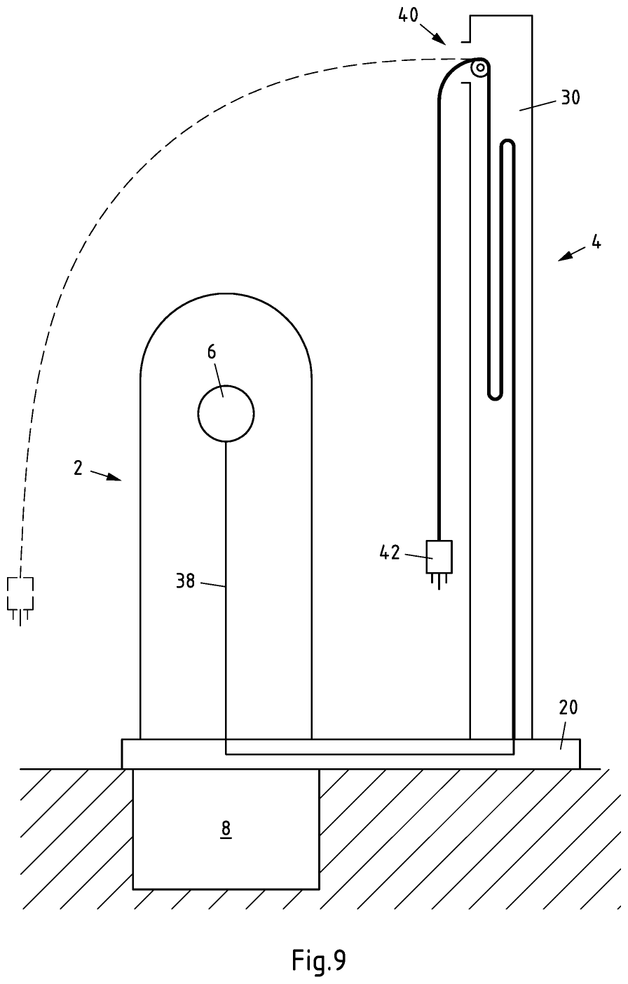

An assembled charging station 4 with pole 30 and housing 2 is shown in FIG. 9. It can be seen that the base plate 20 is attached to the foundation 8. On the base plate 20 stands the housing 2 as well as the pole 30.

In the embodiment shown in FIG. 9 a charging cable 38 is led from the charging electronics 6 through the groove 28 of the base plate 20 to the inside of the pole 30. Inside the pole 30 the charging cable 38 is preferably held by a pulley.

An opening 40 is provided in the upper area of pole 30. The opening 40 preferably has deflection rollers so that the charging cable 38 is not damaged when it is pulled out and pulled into the pole.

The charging cable 38 is shown in the solid line in the rest position. Here the charging cable 38 is pulled into the interior of the pole 30 and the charging cable plug 42 does not rest on the ground. To use the charging cable 38, the user can freely move the charging cable plug 42 and the charging cable 38 and in particular pull the charging cable 38 out of the guide inside the pole 30 and move it into the desired position as shown by the dashed lines. When charging is complete, the charging cable 38 is pulled back into the rest position by the pullley.

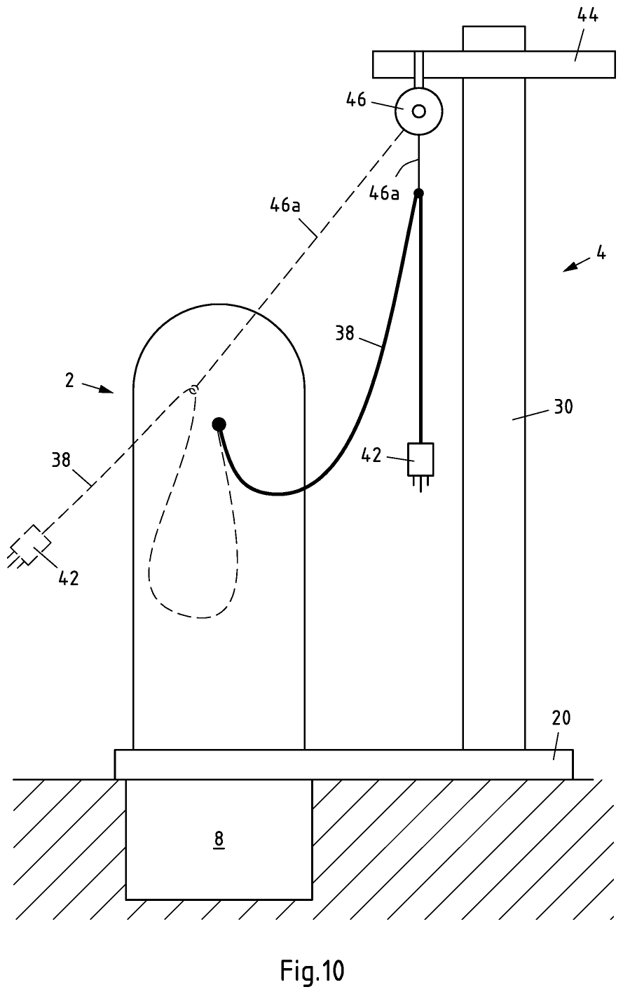

FIG. 10 shows another embodiment in which the charging cable 38 is also fixedly mounted to the housing 2. In this embodiment, a cover 44, for example a cross member and a spring balancerer 46 arranged on it, is provided in the area of the upper end of the pole. Using the spring balancer 46, which is attached to the charging cable 38 via a rope, the charging cable 38 can be pulled into the rest position shown in FIG. 10 (solid line) so that the charging cable connector 42 does not rest on the ground. For use, the user can pull the charging cable 38 into the use position. The spring balancerer 46 releases the cable 46a for this purpose. After use, the charging cable 38 is pulled back into the rest position by the spring balancer 46.

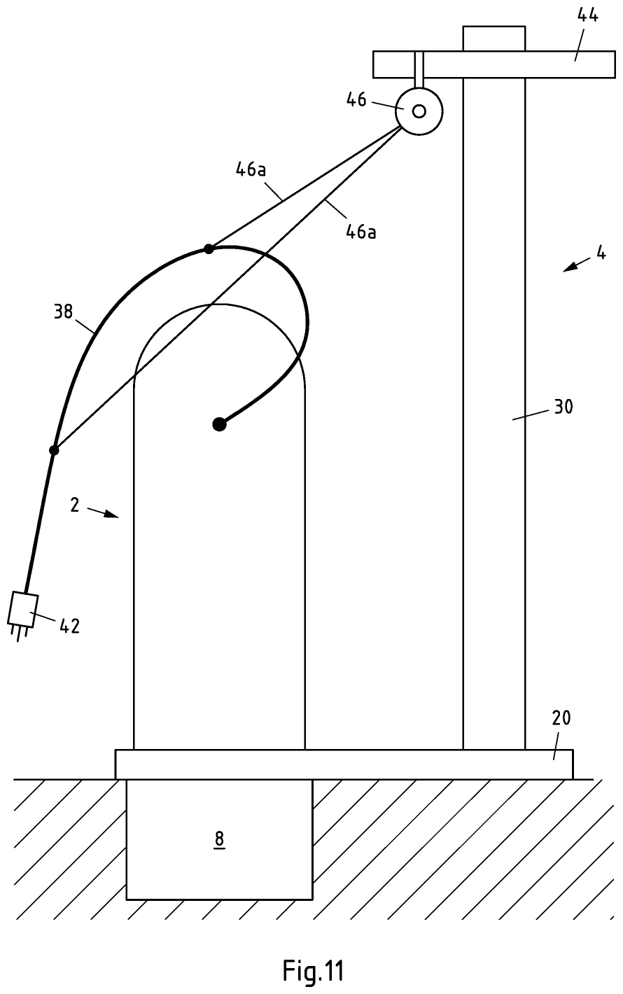

FIG. 11 shows another embodiment of a charging station 4 with a housing 2 and a pole 30. Here the charging cable 38 is connected at several points with a respective rope 46a with a respective spring balancer. This ensures that the charging cable 38 is at least partially balanced in the use position. In particular, the weight of the charging cable 38 is at least partially balanced by the spring balancer 46 and the cable 46a.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A charging station for electric vehicles comprising:
a housing,
charging electronics arranged in the housing,
a pole arranged adjacent to the housing and leading a charging cable out of the housing,
a foundation supporting the housing, and
a base plate is placed onto the foundation,
wherein the housing is placed onto the foundation with its complete base, the base plate being clamped between the housing and an upper side of the foundation, and
wherein the pole is attached to the base plate.

2. The charging station of claim 1, wherein the pole is attached to the base plate on its lower side and that the pole holds the charging cable on its upper side.

3. The charging station of claim 1, wherein the pole has a spring balancer, wherein the charging cable is fastened to the spring balancer and/or wherein the pole has a spring pole, wherein the charging cable is fastened to the spring pole.

4. The charging station of claim 3, wherein the charging cable is connected to the spring balancer at least in the region of the charging cable plug, and/or wherein the charging cable is connected to the spring balancer in a central region between the charging cable plug and the housing.

5. The charging station of claim 1, wherein the base plate is metallic.

6. The charging station of claim 1, wherein the base plate has at least the size of the base area of the housing and of the pole.

7. The charging station of claim 1, wherein the base plate has a flange projecting in the direction of the pole, and wherein the pole encloses the flange on the bottom side.

8. The charging station of claim 1, wherein the base plate has a cable bushing in the region of the housing.

9. The charging station of claim 1, wherein the charging cable is fixedly mounted to the housing.

10. The charging station of claim 1, wherein the pole has a cavity which extends in the longitudinal direction and is open at its lower side, and in particular wherein the charging cable is led into the cavity at the lower side and is led out of the cavity in an upper side of the pole.

11. The charging station of claim 1, wherein the charging cable in the pole is guided by a pulley.

12. The charging station of claim 1, wherein the base plate has a groove arranged between the housing and the holder on the side facing the foundation.
